(19) United States
(12) Patent Application Publication
(10) Pub. No.: US 2017/0167555 A1
(43) Pub. Date: Jun. 15, 2017

(54) Brake System

(71) Applicant: SAF-HOLLAND GmbH, Bessenbach (DE)

(72) Inventor: Olaf Drewes, Aschaffenburg (DE)

(73) Assignee: SAF-HOLLAND GmbH, Bessenbach (DE)

(21) Appl. No.: 15/313,435

(22) PCT Filed: May 15, 2015
(86) PCT No.: PCT/EP2015/060764

§ 371 Date: Nov. 22, 2016

(30) Foreign Application Priority Data
May 23, 2014 (DE) 10 2014 209 909.9

(51) Int. Cl. F16D 65/28

(52) U.S. Cl. CPC F16D 65/28; F16D 2125/66

(57) ABSTRACT

The present invention relates to a brake system comprising an actuating part and a brake part, the actuating part having a pressure chamber and a restoring section, the pressure chamber and the restoring section being separated from one another in a fluid-tight manner by way of a piston, it being possible for the piston to be fixed on an engagement element in such a way that a movement of the piston brings about a movement of the engagement element, the engagement element protruding into the brake part and having, in the brake part, a force section which is designed to transmit a force to a brake means, the brake part and the predominant part of the actuating part being arranged in a housing.

### BACKGROUND OF THE INVENTION

The present invention relates to a brake system, preferably for use in a commercial vehicle or a commercial vehicle trailer.

Brake systems are already sufficiently well known from the prior art. Thus, brake systems which are based on compressed air are usually used in the commercial vehicle field, in which brake systems a compressed air cylinder converts the pneumatic pressure force into a movement of an engagement element, which movement is in turn transmitted to the brake means of the brake, for example brake blocks or brake shoes, in order to initiate a frictional contact and to achieve a braking operation of the commercial vehicle. Here, diaphragm cylinders are widespread as compressed air cylinders, said diaphragm cylinders being fixed on the brake system via corresponding flange geometries. In particular in the field of drum brakes, it is customary to use special compressed air cylinders which achieve the required actuating travels for drum brakes. However, special compressed air cylinders of this type have a high weight and a very high installation space requirement. Furthermore, it is necessary to protect the essential components of a brake system against damage by way of parts which are whirled up during the journey of the commercial vehicle, such as stones. Shielding geometries of this type have had to be designed with a very large volume up to now, since the brake systems which are known from the prior art in turn have a high installation space requirement. In addition, the high weight of the brake systems which are known from the prior art has adverse effects on the resistance of the brake system to vibrations which occur, for example, during driving or during braking.

It is an object of the present invention to provide a brake system which firstly has a lower installation space requirement than the brake systems which are known from the prior art, and secondly has a lower weight than the brake systems which are known from the prior art.

### SUMMARY OF THE INVENTION

According to the invention, the brake system comprises an actuating part and a brake part, the actuating part having a pressure chamber and a restoring section, the pressure chamber and the restoring section being separated from one another in a fluid-type manner by way of a piston, it being possible for the piston to be fixed, or the piston being fixed, on an engagement element in such a way that a movement of the piston brings about a movement of the engagement element, the engagement element protruding into the brake part and having, in the brake part, a force section which is designed to transmit a force to brake means, the brake part and the predominant part of the actuating part being arranged in a housing. The actuating part of the brake system is preferably the part, in which a pressure force, caused, for example, by way of an air pressure, is converted into an axial movement of a driving element, such as a piston. The brake part is preferably the part of the brake system, in which the movement or the displacement of the piston is converted indirectly or directly into a movement of brake means, such as a brake block or a brake shoe of a disk brake. Here, the actuating part has a pressure chamber which serves, in particular, to store a fluid which is at a defined operating pressure, and to receive a piston which is driven by the pressurized fluid. Furthermore, an engagement element is provided which can be fixed on the piston or is preferably fixed on the piston. Here, a positively locking connection of the piston to the engagement element is preferred, in particular, by way of a thread, for example. In an alternative preferred embodiment, the piston is configured in one piece with the engagement element. The engagement element is preferably a body of rod-shaped configuration and transmits a force or a movement of the piston into the brake part of the brake system. Furthermore, in its section which protrudes into the brake part, the engagement element has a force section which is designed to transmit a force to a brake means, preferably a brake block or a brake shoe or a brake caliper. The engagement element is particularly preferably a drive rod for an expansion wedge unit, and the force section is the corresponding wedge geometry which is in engagement directly or indirectly with one or more brake blocks to be pressed apart from one another. The brake part and the predominant part of the actuating part are arranged in a housing. The housing is a body which is configured in the manner of a hollow body in regions, and serves to receive the brake part and a predominant part of the actuating part. In this context, predominant means that the essential components of the actuating part such as the restoring section and at least half the pressure chamber are received in the housing. In other words, the brake system is therefore distinguished by a housing which receiving, in an integral way, the brake part, which can be designed, for example, as an expansion wedge unit of a drum brake, and a predominant part of the actuating part which in other words is the brake cylinder of a vehicle brake. This predominant integration of the brake part and of the actuating part into the housing leads to a particularly compact overall design of the brake system and reduces the weight of the brake system in a preferable way in comparison with brake systems which are known from the prior art.

The engagement element can preferably be moved along an actuating axis by a maximum actuating travel, the maximum actuating travel being in a ratio of from 0.05 to 0.6, preferably of from 0.06 to 0.3 and particularly preferably of from 0.075 to 0.13 to the overall extent of the brake system along the actuating axis. It can be evaluated as an expression for the compactness of the design of the brake system if the brake system overall requires only a relatively small overall length in order to achieve a defined actuating travel of the engagement element. In order, in particular, to satisfy the high requirements for the low installation space requirement, it is preferred that the ratio between the maximum actuating travel of the engagement element and the overall extent of the brake system along the actuating axis lies within a ratio of from 0.05 to 0.6. Here, the upper value of said ratio 0.6 means, in particular, that the actuating travel of the engagement element comprises somewhat more than half the overall length of the brake system. It goes without saying that said value is possible only when the force to be transmitted by the engagement element is relatively low. It goes without saying that, if the engagement element has to apply a higher force in order to actuate the brake means of the commercial vehicle, the corresponding geometries of the actuating part, the brake system and the brake part have to be of greater design in order for it to be possible to absorb and transmit said higher forces. Tests by the applicant have shown that the greatest spectrum of requirements for the brake system can be achieved by way of a ratio range from 0.05 to 0.6. Here, the particularly preferred range from 0.06 to 0.3 is the ratio range which is preferred, in particular, for an expansion wedge unit and in which a particularly favorable compromise can be achieved between the required maximum actuating travel and an overall extent of the brake system which is nevertheless relatively low. Here, the range from 0.075 to 0.13 which is preferred, in particular, has been determined within the context of the present invention to be the region, in which the brake system, even if it comprises further auxiliary parts such as a parking brake part, the best compromise between the maximum actuating travel with an overall extent of the brake system along the actuating axis which is at the same time as low as possible. The maximum actuating travel is advantageously in a ratio of from 0.28 to 0.8, preferably of from 0.4 to 0.7 and particularly preferably of approximately 0.6 to the extent of the actuating part along the actuating axis. The compactness of the actuating part itself can be increased if it is designed in such a way that, in order to achieve a defined maximum actuating travel, the length of the actuating part is kept within the limits proposed here. The minimum value of the ratio of 0.28 is therefore preferred only when the requirements for the strength and operational reliability are so high that a compact overall design is subordinate. The greatest compactness is achieved by way of a ratio of 0.8. The preferred ratio range of from 0.4 to 0.7 permits high service life expectations with a sufficient compactness. Surprisingly, a ratio of 0.6 has demonstrated an optimization of the compromise between weight, compact overall design and strength, in particular for the use in commercial vehicles with a permissible overall weight of greater than 20 t.

In a preferred embodiment, the actuating part is designed for a maximum operating pressure in the pressure chamber of at least 15 bar, preferably of at least 17 bar. In order to achieve said requirement, the brake system preferably has high pressure seals in the region of the piston. Furthermore, the housing preferably has further high pressure seals and/or, for example, self-sealing ISO metric threads in the region, in which it can be closed by way of a cover or by way of an adjacent system. The corresponding wall thicknesses of the actuating part and, in particular, of the housing in the region of the pressure chamber are likewise designed for said pressures of at least 15 bar.

The brake system is advantageously designed for a pressure range of from 6-20 bar, preferably of from 10-18 bar and particularly preferably of from approximately 15-18 bar. Within the context of the present invention, the pressure range of from 6-20 bar has been determined as sufficient for achieving weight and installation optimization as a result of a reduction of the cross sections of the housing. Here, the required brake forces have been able to be applied for all common commercial vehicles by way of a brake system according to the invention. With the above-described advantages, the range of from 10-18 bar has proven itself as an optimum pressure range, in particular, for relatively light commercial vehicles, such as relatively small trucks and buses. For heavy commercial vehicles with correspondingly high drum brake diameters, it has proven particularly advantageous to use a pressure range of from 15-18 bar, since the brake system is always capable of applying the required brake force by way of said pressures.

The housing is particularly preferably of cylindrical configuration and has a mean diameter, the housing having a minimum wall thickness in the region of the pressure chamber, the minimum wall thickness being in a ratio of from 0.01 to 0.2, preferably of from 0.03 to 0.1 and particularly preferably of from approximately 0.06 to 0.1 to the mean diameter. In order for it to be possible to withstand the preferably particularly high pressures in the pressure chamber of particularly preferably over 17 bar, the housing of the brake system preferably has a minimum wall thickness which is in a ratio of from 0.01 to 0.2 to the mean diameter of the housing. It has been shown here that the greatest possible ratio range of from 0.01 to 0.2 is sufficient, in order for it to be possible to withstand all pressures provided within the context of the present invention and in the process to also ensure a sufficient safety factor. Here, the preferred ratio range of from 0.03 to 0.1 has proven itself, in particular, in respect of commercial vehicle brakes, in which brake systems are used with a housing which is preferably manufactured from steel. It has been shown that particularly satisfactory weight savings with simultaneously sufficiently high safety factors are possible in the preferred ratio range of from 0.03 to 0.1. The particularly preferred range of from 0.06 to 0.1 has proven itself, in particular, in brake systems which can also be used in passenger motor vehicles, since it firstly sufficiently high safety against failure, for example as a result of the maximum pressure to be withstood by the housing wall being exceeded, and secondly particularly efficient installation space reduction, since particularly high pressures can preferably be used in the brake system in the case of a wall thickness of the housing wall which lies in the range from 0.06 to 0.1 of the mean diameter of the housing. As a result of said high pressures, the force which can be applied by the brake system also increases, and a brake system or a housing with a smaller extent transversely with respect to the actuating axis can therefore be selected which in turn has a low installation space requirement and a lower weight. The mean value between the diameter of the outer surface or outer wall of the housing and the inner wall of the housing and also the arithmetic mean of various mean diameters which are threaded next to one another along the actuating axis is preferably defined as the mean diameter. In other words, although the housing is of substantially cylindrical configuration, there can also be locally different, mean diameters, in particular as a result of local reinforcements, thickened material portions or flanges used for attaching the housing to a chassis structure or for attaching further elements to the housing. Therefore, a deviation from the cylindrical shape of the housing can also be provided locally within the context of the present invention.

The housing is advantageously configured in one piece, the housing preferably being configured as an expansion wedge unit in the region of the brake part. In particular, it is preferred here that the housing is configured as a conventional expansion wedge unit in the region of the brake part, that is to say preferably in the region, in which the engagement element has a force section. In this way, the brake system according to the invention can be used in brakes which are already in use, for example for drum brakes of a commercial vehicle, without it being necessary for modifications to be performed on the further force transmission chain or the force transmission system of the existing brake arrangement. Here, expansion wedge units per se can be presumed to be known from the prior art. Here, the present invention advantageously provides that the housing firstly encloses a conventional expansion wedge unit and secondly is configured in one piece with further parts, such as the actuating part of the brake system, with the result that, in other words, a brake cylinder which has previously had to be attached separately to the brake system can now be integrated partially into the housing of the expansion wedge unit within the context of the present invention. In this way, not only can installation space be saved, but rather a simplification of the assembly can also be achieved, since fewer parts which are provided separately from one another have to be assembled. Furthermore, the susceptibility to faults of the brake system drops as a result of the integration of the actuating part into the housing, in which the expansion wedge unit is also situated, since fewer interfaces such as flanges and further connecting regions which tend toward leaks or damage are provided between different systems of the brake system. Here, in particular, the housing is preferably configured as a single-piece cast part. As an alternative, a housing which is constructed from a fiber composite material can also preferably be provided, which housing has, in particular, advantages with regard to the tensile strength in certain directions such as, for example, in the circumferential direction, in order for it to be possible to withstand the high pressures which are preferably provided in the brake system in a more improved manner than, for example, a cast part can be capable of withstanding. Here, in particular, a frame made from mesh material or a woven fiber composite frame can be used, which reinforces the housing locally or completely against tensile stresses in preferably the circumferential direction. Furthermore, it is preferred that the housing is manufactured from GLARE, a fiber-reinforced aluminum cast material. Here, GLARE combines firstly the light construction of aluminum with the high tensile strength of the aramid or carbon fibers which are cast into the aluminum and drastically increase the tensile strength in the respectively desired directions. In particular, Barlow's formula which is defined according to DIN can be used for calculating the forces which occur in the circumferential and axial direction in the housing wall.

In one particularly preferred embodiment, the engagement or actuating element and the piston are arranged completely within the housing. This applies, in particular, preferably to all operating states of the brake system, that is to say also to that operating state, in which the piston is at its maximum spacing from the brake part of the brake system. On its side which faces away from the brake part, the housing advantageously has a stop for the piston, which stop can particularly preferably be introduced, for example by way of screwing or welding, after the engagement or actuating element and the piston have been pushed into the housing. The advantage of the complete arrangement of the engagement or actuating element and the piston within the housing lies in the fact that the brake system which is thus approximately complete can be attached as one part to the commercial vehicle chassis and can be dismantled as one part from the latter, and therefore the assembly is greatly simplified. This effect can be increased further by the pressure chamber preferably also being arranged completely within the housing, the housing being closed by way of a component which acts as a cover element, such as a cover. Here, the single-piece configuration of the housing is particularly suitable for transmitting the high forces which act in the pressure chamber and in the region of the piston, since no susceptible interfaces are provided between individual regions of the actuating part or the brake part.

The housing advantageously has a fluid nozzle which is configured on the outer side of the housing for the connection of a pressure line and opens on the inner side of the housing into the pressure chamber. The connector for the pressure line is advantageously configured in one piece with the housing, by way of which connector the brake system is loaded with the necessary operating pressure. It is advantageous here that the fluid nozzle is formed integrally onto the housing, for example by way of casting or being manufactured at the same time as the housing. The notch effect in the region of the fluid nozzle can be reduced considerably, in particular, by way of a preferred rounded configuration of the transition of the wall of the fluid nozzle into the wall of the housing.

Furthermore, the housing preferably has a flange section which is designed for fixing the housing on a chassis element of a commercial vehicle. It is particularly preferred that the housing can fulfill as many functions as possible of the brake system, thus also the preferred fixing of the brake system on the chassis of the commercial vehicle. To this end, the housing preferably has a flange section which is configured in one piece with the housing and can be fixed on the brake carrier of a commercial vehicle, for example, by way of bolt or pin connection. In this way, the strength of the connection between the housing, the flange section and the chassis of the commercial vehicle can be increased. In particular, it can be preferred here that the housing is configured in one piece with the brake carrier, it being possible for the strength of the connection and the simplification of the assembly to be increased further.

A first restoring element is advantageously arranged in the restoring section, which first restoring element exerts a force on the piston along an actuating axis in the direction of the pressure chamber. It has proven advantageous here that the restoring element in the restoring section is also arranged within the housing which is configured in one piece, as a result of which a saving of installation space and weight can once again be achieved. Here, the first restoring element is advantageously supported on a geometry of the housing provided for this purpose or on an element which is arranged in the housing, and develops a force which acts on the piston and attempts to move the latter in the direction of the pressure chamber. In this way, in the case of ventilation of the pressure chamber, the piston is moved together with the engagement element out of the brake part, as a result of which the brake means of the commercial vehicle particularly preferably pass out of engagement.

In one particularly preferred embodiment, the first restoring element is prestressed in every operating state of the brake system. In particular, the first restoring element is then also preferably prestressed when the piston is arranged in its position, in which it is spaced apart the furthest from the brake part of the brake system. In this way, an accurate cancellation of the braking action and therefore free driving of the commercial vehicle can be ensured in every operating state of the brake system. Here, the prestress of the first restoring element is designed, however, in such a way that it is readily possible for a mechanic of the brake system to be able to manually move the piston into its position, in which it is arranged the furthest from the brake part, in order subsequently, for example, to arrange the stop, against which the piston bears, in the housing.

Furthermore, the housing preferably has a supporting section, against which the first restoring element is supported along the actuating axis and/or which secures the engagement element against movement transversely with respect to the actuating axis. The supporting section of the housing is advantageously arranged in the region between the brake part and the actuating part of the housing. Here, the supporting section serves firstly to support the first restoring element, in order to prestress the latter in the direction of the piston. As an alternative or in addition, the supporting section also preferably serves to support the engagement element against movement transversely with respect to the actuating axis, a movement of the engagement element along the actuating axis being ensured at the same time. Here, the supporting section can preferably be configured as an element which is introduced, for example screwed, into a corresponding engagement geometry of the housing, and can preferably be of annular configuration. As an alternative, the supporting section is preferably configured in one piece with the housing.

Furthermore, the brake system particularly preferably comprises a parking brake unit which is arranged so as to adjoin the pressure chamber, the parking brake unit having a second restoring element and a parking brake accumulator which are separated from one another in a fluid-tight manner by way of a parking brake piston, the parking brake piston being designed to transmit a force indirectly or directly to the engagement element. The parking brake unit preferably fulfills the function of a parking brake which is known from the prior art, a second restoring element preferably being provided, in particular, during a ventilation, that is to say during a reduction in the operating pressure in the parking brake accumulator, which second restoring element transmits a force indirectly or directly via the parking brake piston to the engagement element, in order to move the latter into its position, in which it moves the brake means of the commercial vehicle into its braking position. Here, the second restoring element advantageously has a substantially higher spring force or constant than the first restoring element, in order to overcome the force of the latter which counteracts the second restoring element and to cause a braking operation of the commercial vehicle in the case of a complete ventilation of the entire brake system. Here, in the case of a system failure of the pressure system of the commercial vehicle, a braking operation can advantageously be initiated by way of the brake system, since the force of the second restoring element is sufficient, in order to overcome the force of the first restoring element and nevertheless to achieve a sufficiently high residual force for moving the engagement element into a braking position. It is particularly preferred here that the parking brake unit is also arranged in regions within the housing, it being possible for corresponding separating geometries between the actuating part and the parking brake unit to be introduced into the housing and to be fixed on the latter. In this way, a further increase in the compactness of the brake system can be achieved. Furthermore, the susceptibility to faults of the brake system can be reduced, since further interfaces can be dispensed with between the parking brake unit and the actuating part of the brake system, which interfaces can be susceptible, in particular, to leaks and, in the case of vibrations, also to mutual damage.

Furthermore, the parking brake unit preferably has a parking brake housing which can be connected in a fluid-tight manner to the housing. As an alternative to the single-piece configuration of the housing of the parking brake unit and the actuating part, the parking brake unit can also have a parking brake housing of separate configuration. This serves, in particular, to facilitate the maintenance of the brake system, since the parking brake unit can be removed from the housing, in order to perform individual maintenance steps. For the fluid-tight connection of the parking brake housing to the housing, it is preferred that seal elements and corresponding flange geometries are provided both on the parking brake housing and on the housing.

It is preferred in a first embodiment that the pressure chamber is delimited by a wall of the parking brake housing. Here, access to the pressure chamber can advantageously be provided directly by way of dismantling of the parking brake housing from the housing. The maintenance work can be facilitated drastically in this way.

In one alternative preferred embodiment, the parking brake accumulator is delimited by a wall of the housing. In said alternative preferred embodiment, the housing can advantageously be designed for higher pressures in the pressure chamber, lower pressures preferably being expected in the parking brake chamber, and the interface between the housing and the parking brake housing therefore preferably being positioned in the region of the parking brake chamber. Here, a compressed air feed stub which opens into the parking brake accumulator is advantageously situated in the region of the wall of the housing, it being possible for the parking brake housing to be dismantled from the housing without it being necessary at the same time to dismantle the compressed air lines. In this way, the assembly complexity of the brake system can be reduced significantly. Here, the wall of the housing which delimits the parking brake accumulator is preferably arranged in a cover element which is fixed on the housing.

### BRIEF DESCRIPTION OF THE DRAWINGS

Further advantages and features of the present invention result from the following description with reference to the appended figures. It goes without saying here that individual features which are shown in only one of the embodiments can also be used in other embodiments of the brake system, as long as this has not been ruled out explicitly or is prohibited on account of the design of the brake system. In the drawing:

FIG. 1 shows a sectional view of a first preferred embodiment of the brake system according to the invention;

FIG. 2 shows a sectional view of a second embodiment of the brake system according to the invention; and

FIG. 3 shows a sectional view of the embodiment from FIG. 2.

### DETAILED DESCRIPTION OF THE PREFERRED EMBODIMENTS

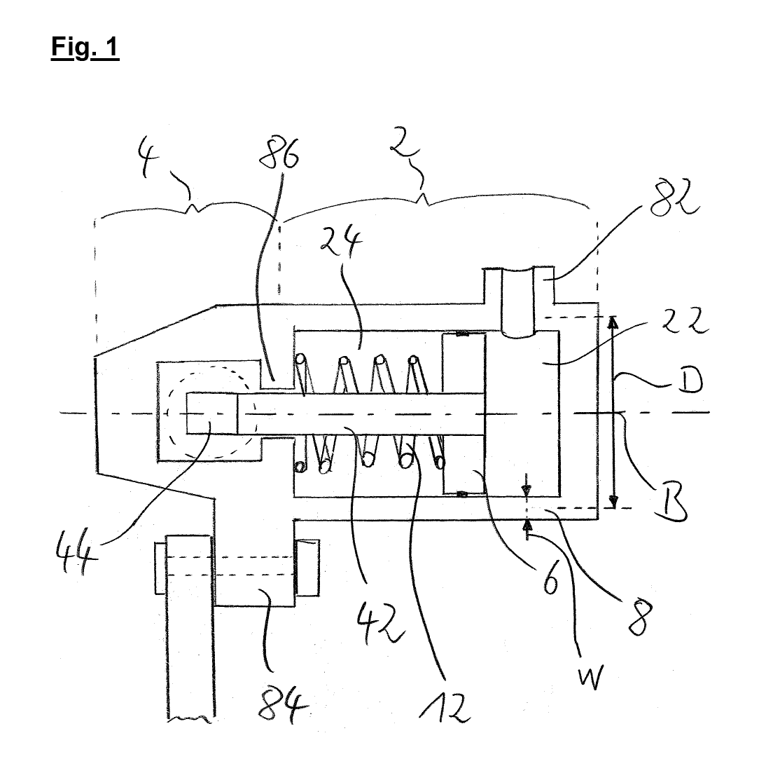

FIG. 1 diagrammatically shows a sectional view of a preferred brake system. Here, the brake system has an actuating part 2 and a brake part 4, both the actuating part 2 and the brake part 4 preferably being arranged completely within a housing 8. The actuating part 2 advantageously comprises a pressure chamber 22 and a restoring section 24 which are separated from one another in a fluid-tight manner by way of a piston 6. A first restoring element 12 is arranged in the restoring section 24, which first restoring element 12 exerts a force on the piston 6, in order to move the latter in the direction of the pressure chamber 22. The piston 6 is advantageously connected fixedly to an engagement element 42, with the result that a movement of the piston 6 along the actuating axis B always leads to a movement of the engagement element 42 together with the piston 6. Here, the piston 6 is particularly preferably configured in one piece with the engagement element 42. On its region which protrudes into the brake part 4, the engagement element 42 has a force section 44. Here, the force section 44 is preferably a wedge geometry which is designed for actuating the expansion wedge unit of an expansion wedge drum brake. Between the actuating part 2 and the brake part 4, the housing 8 advantageously has a supporting section 86 which firstly serves to support the first restoring element 12 and, as an alternative or in addition, preferably also prevents a movement of the engagement element 42 transversely with respect to the actuating axis B. Furthermore, the housing 8 preferably has a flange section 84 which, as shown diagrammatically in the figure, is designed for fixing on the indicated chassis of a commercial vehicle.

It is particularly preferred here that the flange section 84 is configured in one piece with the housing 8, in order for it to be possible particularly preferably to withstand high forces and in order to simplify the assembly of the brake system. Furthermore, the housing 8 advantageously has a fluid nozzle 82 which is provided for connecting a pressure line to the housing 8 and introducing a fluid, such as compressed air, into the pressure chamber 22. It is not shown in the figure that a cover element 14 can preferably be attached to the housing 8 on the right-hand side of the pressure chamber 22, which cover element 14 replaces the right-hand wall of the pressure chamber 22 which is shown only diagrammatically in the figure, and therefore ensures the delimiting of the pressure chamber 22 on the side which faces away from the piston 6. Furthermore, the figure shows the minimum wall thickness w of the housing. Here, the minimum wall thickness w is particularly preferably measured in the region of the actuating part 2; in particular, the minimum wall thickness w is preferably provided in the region of the pressure chamber 22. Furthermore, the mean diameter D of the housing is shown, which mean diameter D is preferably measured in each case in the center of the housing wall in the case of a preferably cylindrically configured housing 8.

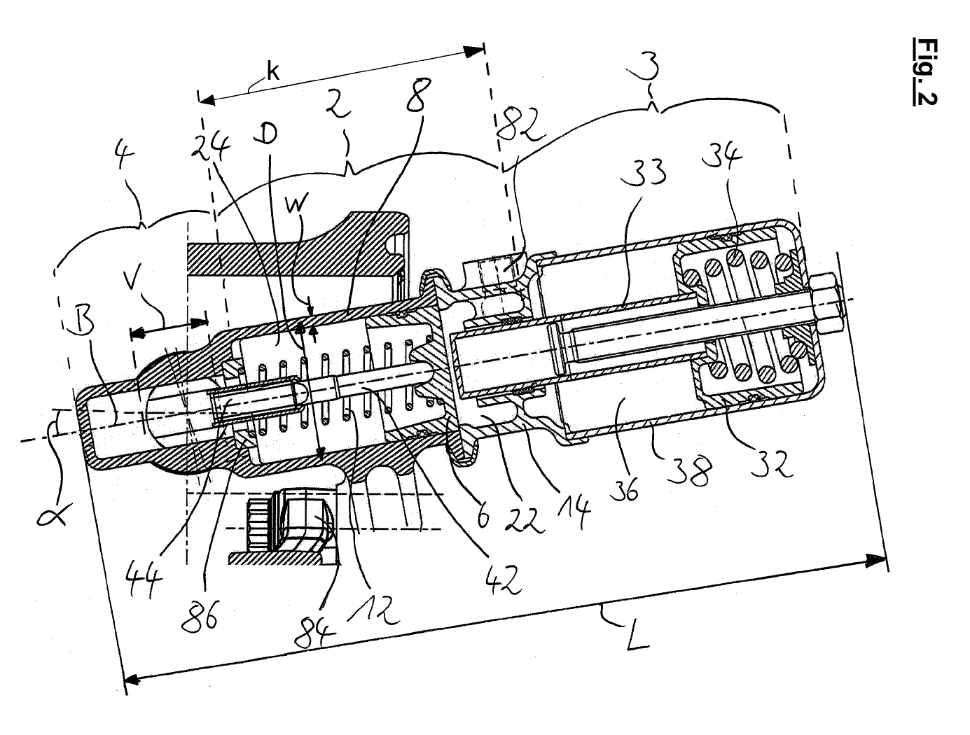

FIG. 2 shows a further preferred embodiment of the brake system according to the invention, a parking brake unit 3 also being provided in addition to the brake part 4 and the actuating part 2, which parking brake unit 3 adjoins the pressure chamber 22. Here, in the preferred embodiment which is shown in FIG. 2, a cover element 14 is provided which is fixed to the housing 8 with a positively locking connection. Here, the cover element 14 preferably forms a part of the housing 8. Furthermore, the cover element 14 preferably has a fluid nozzle 82 here for the supply of pressure fluid, such as compressed air, into the pressure chamber 22. Furthermore, a feed stub (not shown) for feeding compressed air into the parking brake accumulator 36 is also preferably provided on the housing. Here, the brake part 4 and the actuating part 2 of the embodiment which is shown in FIG. 2 have substantially the same features as in the embodiment which is shown in FIG. 1. The parking brake unit 3 preferably comprises a parking brake piston 32 which can be moved along the actuating axis B within a parking brake housing 38, and a region, in which a second restoring element 34 is arranged and separates the parking brake accumulator 36 from one another in a fluid-tight manner. Moreover, the parking brake piston 32 has a parking brake means 33 which is designed to transmit a force which is applied by the second restoring element 34 to the piston 6. Here, FIG. 2 shows an operating state of the brake system, in which the parking brake element 33 does not transmit any force to the piston 6. The reason for this is that a fluid is introduced in the parking brake accumulator 36 at a pressure which overcomes the restoring force of the second restoring element 34 and therefore ensures that the parking brake piston 32 is moved to the right in the figure and therefore the parking brake element 33 also moves away from the piston 6 and does not transmit any force to the latter. Furthermore, the figure shows the overall length L of the brake system which is particularly preferably very low within the context of the present invention. Here, in the normal operation of the brake system, the actuating element 22 covers a maximum actuating travel v which is in a preferred ratio of from 0.05 to 0.6 to the overall extent L of the brake system along the actuating axis B. This dimension is an expression for the particularly preferred, compact overall design of the brake system. Furthermore, FIG. 2 shows a preferred pivoting angle α, about which, pivoted relative to the horizontal, the actuating axis B of the brake system preferably runs. As a result of the compact overall design of the brake system and a resulting low risk of coming into contact with further components of the commercial vehicle chassis, the pivoting angle α can be kept as low as possible. It is preferred here that the pivoting angle α lies in the range from −5° to 12°, preferably from 0° to 10° relative to the horizontal. Furthermore, preferably and in the case of a particularly preferred compact overall design, as shown in FIG. 2, the pivoting angle α can lie in the range from 5′ to 10°. The maximum actuating travel v advantageously lies in a ratio of from 0.28 to 0.8, preferably of from 0.4 to 0.7 and particularly preferably of approximately 0.6 to the extent k of the actuating part 2 along the actuating axis B.

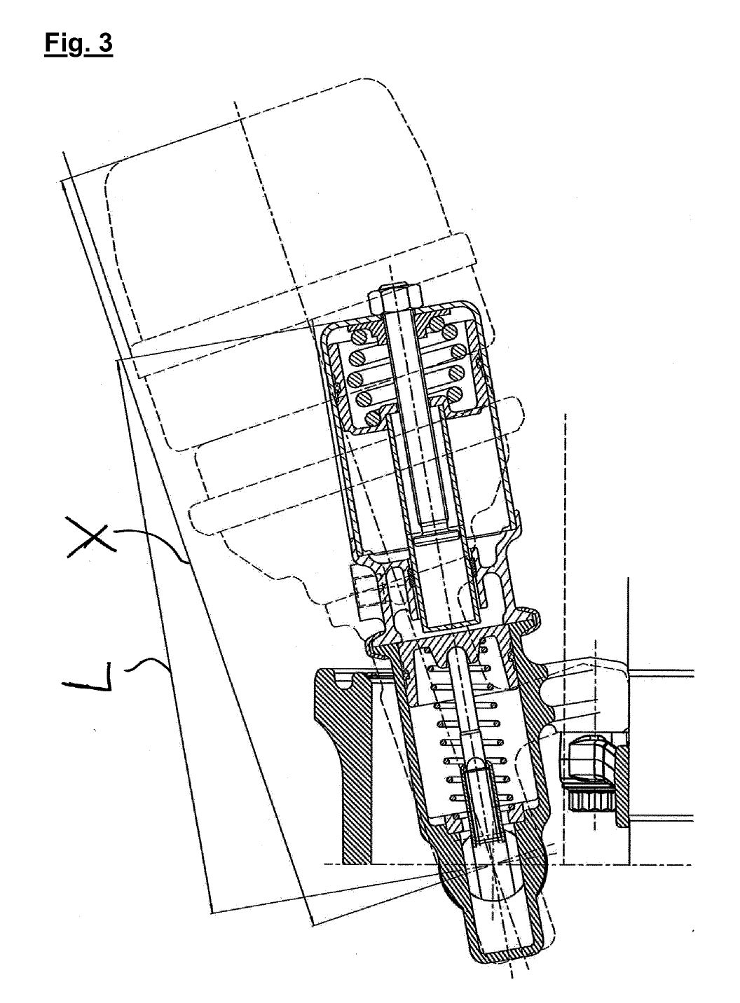

FIG. 3 shows the embodiment from FIG. 2, a conventional brake system being shown using dashed lines. Within the context of the present invention, a solution has been found, by way of which the installation space requirement of a brake system can be reduced drastically, the requirements on the brake system, in particular with regard to the force to be applied, and also with regard to the actuating travel v remaining the same. FIG. 3 illustrates here how pronounced the installation space saving is that results by way of a brake system according to the invention. Here, the overall extent L of the preferred embodiment of the brake system according to the invention is approximately one third lower than the overall length X of a conventional brake system. In addition, partially as a consequence of the low overall extent L, the brake system according to the invention can be arranged pivoted by a smaller pivoting angle α between the axial direction of the chassis and the actuating axis B than the conventional brake system. As a result, the maximum extent of the brake system transversely with respect to the axial direction of the chassis is also reduced.

### LIST OF DESIGNATIONS

2—Actuating part
3—Parking brake part
4—Brake part
6—Piston
8—Housing
12—First restoring element
14—Cover element
22—Pressure chamber
24—Restoring section
32—Parking brake piston
33—Parking brake means
34—Second restoring element
36—Parking brake accumulator
38—Parking brake housing
42—Engagement element
44—Force section
82—Fluid nozzle
84—Flange section
86—Supporting section
α—Angle
B—Actuating axis
D—Mean diameter
k—Extent, actuating part
L—Overall extent
v—Actuating travel
w—Wall thickness
X—Overall length

1.-14. (canceled)

15. A brake system, comprising:
an actuating part; and
a brake part;
wherein the actuating part has a pressure chamber and a restoring section, the pressure chamber and the restoring section being separated from one another in a fluid-tight manner by a piston, wherein the piston is configured to be fixed on an engagement element such that a movement of the piston brings about a movement of the engagement element, the engagement element protruding into the brake part and having, in the brake part, a force section configured to transmit a force to a brake structure, the brake part and the restoring section and at least half of the pressure chamber of the actuating part being arranged in a one-piece housing, the housing being configured as an expansion wedge unit in the region of the brake part.

16. The brake system as claimed in claim 15, the engagement element configured to move along an actuating axis by a maximum actuating travel, the maximum actuating travel being in a ratio of from 0.05 to 0.6 to the overall extent of the brake system along the actuating axis.

17. The brake system of claim 16, wherein the ratio is from 0.06 to 0.3.

18. The brake system of claim 17, wherein the ratio is from 0.075 to 0.13.

19. The brake system as claimed in claim 15, wherein the actuating part is configured for a maximum operating pressure in the pressure chamber of at least 15 bar.

20. The brake system as claimed in claim 19, wherein the maximum operating pressure is at least 17 bar.

21. The brake system as claimed claim 15, wherein the housing comprises a cylindrical configuration having a mean diameter, the housing having a minimum wall thickness in the region of the pressure chamber, the minimum wall thickness being in a ratio of from 0.01 to 0.2 to the mean diameter.

22. The brake system as claimed in claim 21, wherein the ratio of the minimum wall thickness to the mean diameter is from 0.03 to 0.1.

23. The brake system as claimed in claim 22, wherein the ratio of the minimum wall thickness to the mean diameter is from 0.06 to 0.1.

24. The brake system as claimed in claim 15, wherein the engagement element and the piston are arranged completely within the housing.

25. The brake system as claimed in claim 15, wherein the housing includes a fluid nozzle which is configured on an outer side of the housing for the connection of a pressure line and opens on an inner side of the housing into the pressure chamber.

26. The brake system as claimed in claim 15, wherein the housing includes a flange section which is configured to fix the housing on a chassis element of a commercial vehicle.

27. The brake system as claimed in claim 15, wherein a first restoring element is arranged in the restoring section, the first restoring element configured to exert a force on the piston along an actuating axis in the direction of the pressure chamber.

28. The brake system as claimed in claim 27, wherein the first restoring element is prestressed in every operating state of the brake system.

29. The brake system as claimed in claim 27, wherein the housing includes a supporting section against which the first restoring element is supported along the actuating axis and/or which secures the engagement element against movement transversely with respect to the actuating axis.

30. The brake system as claimed in claim 15, comprising a parking brake unit configured to adjoin the pressure chamber, the parking brake unit having a second restoring element and a parking brake accumulator which are separated from one another in a fluid-tight manner by way of a parking brake piston, the parking brake piston configured to transmit a force indirectly or directly to the engagement element.

31. The brake system as claimed in claim 30, wherein the parking brake unit includes a parking brake housing configured to be connected in a fluid-tight manner to the housing.

32. The brake system as claimed in claim 30, wherein the pressure chamber is delimited by a wall of the parking brake housing.

33. The brake system as claimed in claim 30, wherein the parking brake accumulator is delimited by a wall of the housing.
